(19) United States
(12) Patent Application Publication
(10) Pub. No.: US 2017/0052767 A1
(43) Pub. Date: Feb. 23, 2017

(54) VISUAL RULE LANGUAGE SYSTEMS AND METHODS FOR ENTERPRISE BUSINESS SOFTWARE

(71) Applicant: CITIUS SOFTWARE CORPORATION dba KBMax, Austin, TX (US)

(72) Inventors: Kevin Samuel BENNETT, Portland, OR (US); Randall Vette HUCK, Providence, RI (US)

(73) Assignee: CITIUS SOFTWARE CORPORATION dba KBMax, Austin, MN (US)

(21) Appl. No.: 15/243,573

(22) Filed: Aug. 22, 2016

Related U.S. Application Data
(60) Provisional application No. 62/207,534, filed on Aug. 20, 2015.

(51) Int. Cl. G06F 9/44

(52) U.S. Cl. CPC G06F 8/34; G06F 8/31

(57) ABSTRACT

Embodiments for generating programming code by a processor are described. A plurality of shapes are displayed on a display device. Each of the plurality of shapes is associated with a respective functionality of programming code. User input is received. Based on the user input, the plurality of shapes are arranged on the display device. Based on said arrangement of the plurality of shapes, programming code is generated. A total functionality of the generated programming code includes the respective functionality of programming code associated with each of the plurality of shapes.

### CROSS-REFERENCE TO RELATED APPLICATIONS

This application claims priority to U.S. Provisional Patent Application No. 62/207,534, filed on Aug. 20, 2015, which is herein incorporated by reference for all purposes.

### BACKGROUND OF THE INVENTION

Field of the Invention

The present invention relates to computing systems and methods, and more particularly, to various embodiments for programming software for the purposes of defining a specific and often complicated algorithm which may be used in, for example, business logic for determining product prices, configurations, and manufacturing-related design, including those that program 3D printing machinery and CAD models.

Description of the Related Art

With the developing trend of on-demand manufacturing, 3D printing, and more customized product configurations, there has been a growing demand for cloud-based software platforms allowing, for example, the configuration of products, including such features as automated pricing, part numbers, proposals (e.g., configure price quote (CPQ)), the automated building of CAD models, 3D-printed models, and other on-demand manufacturing processes. These customizations are bound by many rules which can be based on very complicated algorithms which are known best by the mechanical engineers who designed them, who do not necessarily possess the software engineering expertise to easily and effectively program these algorithms using traditional tools which require extensive research and training.

There is a need to provide the user with an easy and intuitive system and method for generating programming expressions.

### SUMMARY OF THE INVENTION

Various embodiments for generating programming code are described. In one embodiment, by way of example only, a method, by a processor, for generating programming code is provided. A plurality of shapes are displayed on a display device. Each of the plurality of shapes is associated with a respective functionality of programming code. User input is received. Based on the user input, the plurality of shapes are arranged on the display device. Based on said arrangement of the plurality of shapes, programming code is generated. A total functionality of the generated programming code includes the respective functionality of programming code associated with each of the plurality of shapes.

The generated programming code may be text-based programming code. The text-based programming code may be, for example, Javascript or C++. The text-based programming code may be displayed on the display device. The plurality of shapes may includes a plurality of polygons. At least a portion of each of the plurality of shapes may be non-alphanumeric.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1-4 illustrate various shapes that may be used to generate programming code according to embodiments of the present invention;

FIG. 5 illustrates an example of programming code according to embodiments of the present invention;

FIG. 6 illustrates text-based programming code that may be generated based on the programming code of FIG. 5 according to embodiments of the present invention;

FIG. 7-58 illustrate various shapes, or blocks, and features associated with those shapes that may be used to generate programming code according to embodiments of the present invention;

FIG. 59 is a flowchart diagram depicting an exemplary method for generating programming code in which various aspects of the present invention may be implemented; and

FIG. 60 is a block diagram depicting an exemplary computing node according to embodiments of the present invention.

### DETAILED DESCRIPTION OF THE DRAWINGS

With the developing trend of on-demand manufacturing, 3D printing, and more customized product configurations, there has been a growing demand for, for example, cloud-based software platforms allowing the automated building of CAD models, 3D-printed models, and other on-demand manufacturing processes. These customizations are bound by many rules which can be based on very complicated algorithms which are known best by the mechanical engineers who designed them, who do not necessarily possess the software engineering expertise to easily and effectively program these algorithms using traditional tools which require extensive research and training.

The methods and systems for programming software described herein (referred to as “snap,” “snap code,” “snap environment,” “snap language,” etc.) are designed to require minimal training and may be used without any special software tools, such as integrated development environments and compilers. Instead, they can be used on, for example, any modern browser, and in some embodiment, automatically compile into any machine-readable programming language of one's choice (e.g., Javascript, Java, C++, C#, Python, etc.)

In simple terms which will be expanded on below, in some embodiments, snap code includes of shapes (e.g., at least partially non-alphanumeric polygons or blocks) representing programming expressions which may be connected to other blocks to form full expressions and operations. As such, embodiments described herein may be considered to be visual rule language systems and methods for, as an example, enterprise business software.

The expressions and operations are designed to be powerful, yet easy to use. Like any programming language, snap code may follow a strict syntax which must be followed in order to be parsed and compiled. However, in some embodiments, these are enforced using connectors rather than typing code into a text editor and fixing syntax errors.

In some embodiments, snap code is also a strictly typed language, and in addition to pre-defined primitive and complex types, allows one to define their own types in an object-oriented manner. Certain blocks may expect a block of a specific type to be connected, and a validation mechanism may enforce this expectation, with descriptive errors explaining why two connected blocks are invalid. Other validation which occurs before runtime may also be enforced, even those with specific business logic, which in most programming languages would necessarily be a runtime-level enforcement.

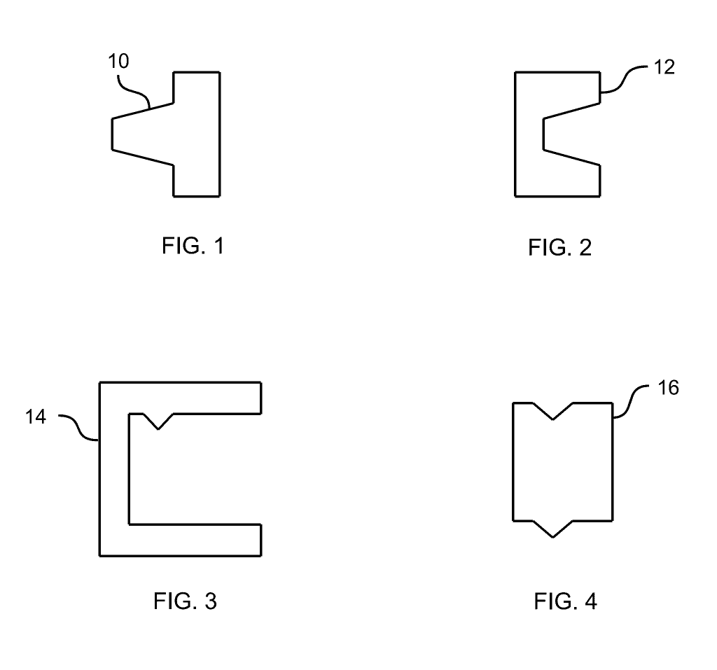

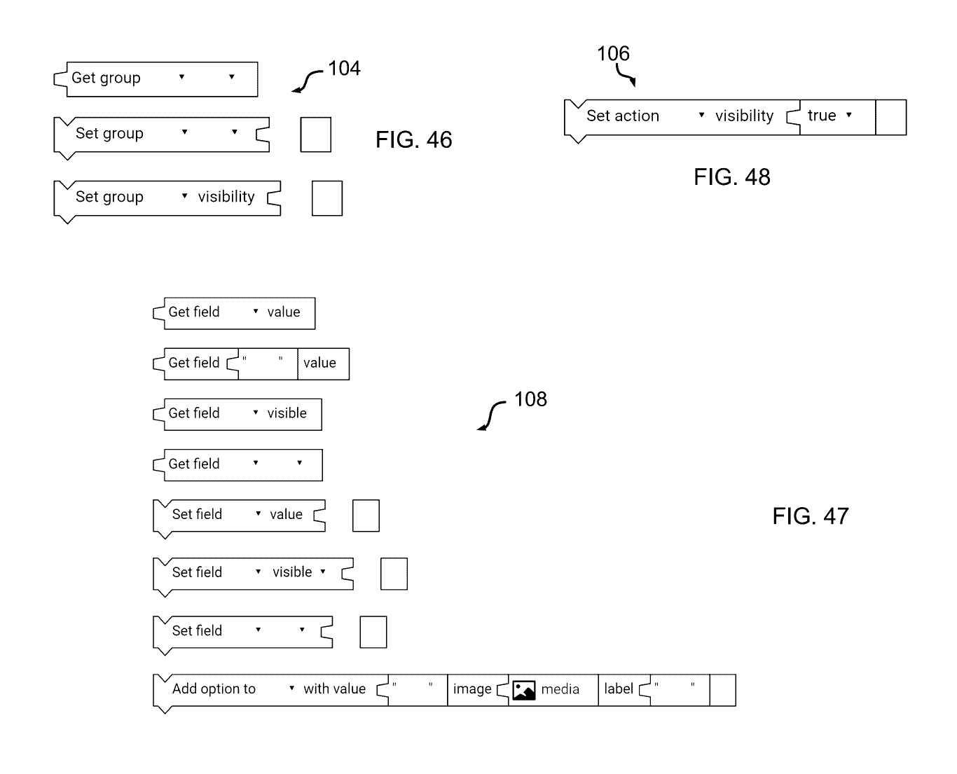

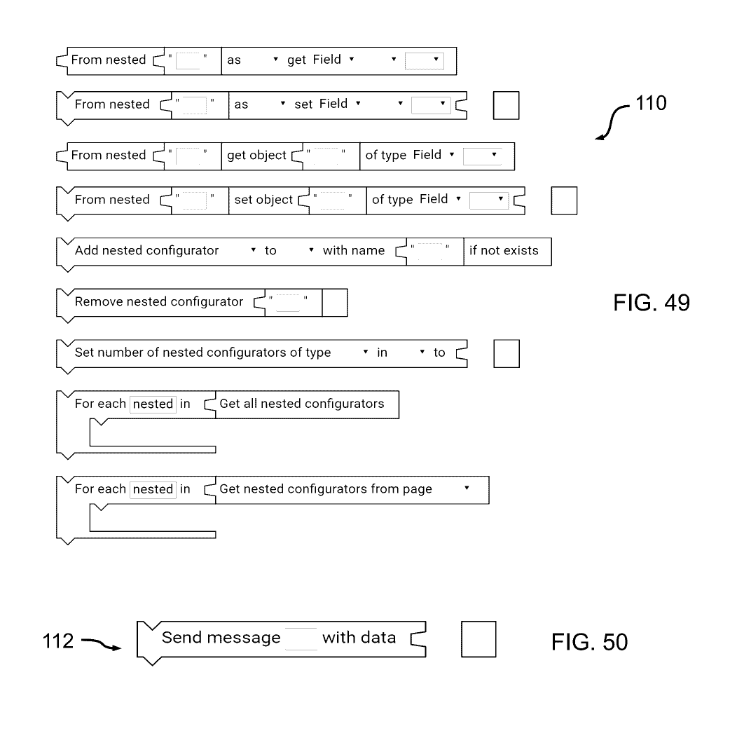

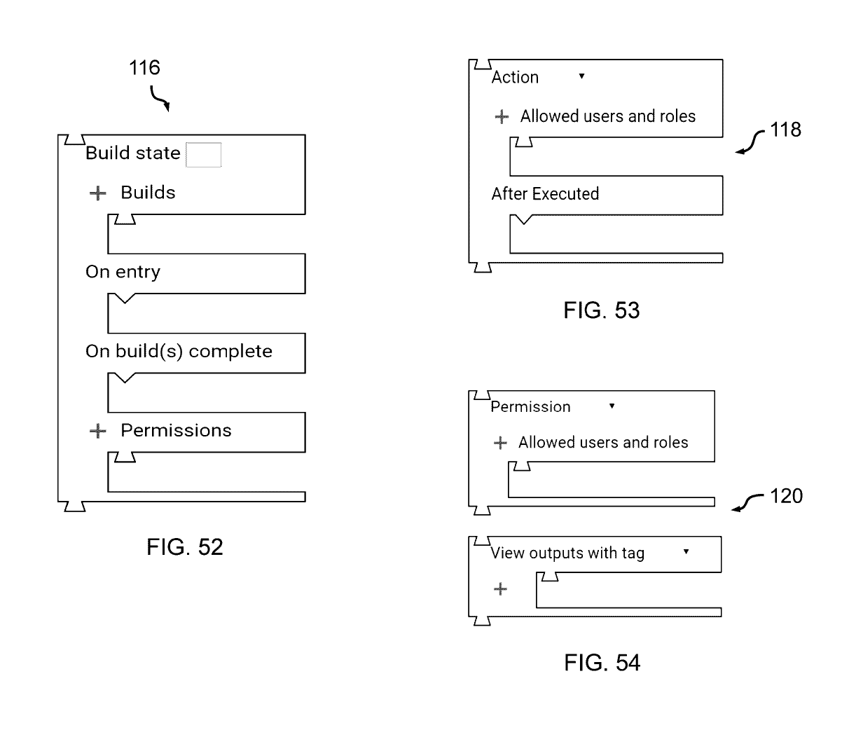

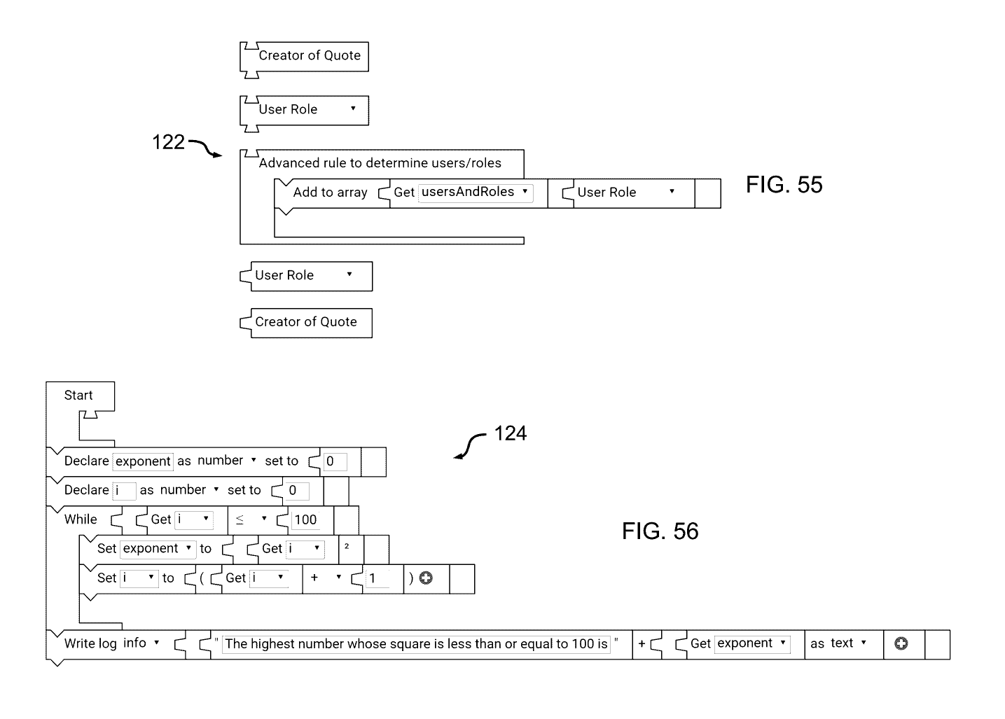

Various aspects, terms, and features according to various embodiments of the present invention are described below, with reference to FIGS. 1-58. It should be understood that FIGS. 1-58 illustrate various “screen shots,” showing different shapes, polygons, etc. (e.g., “blocks,” “connectors,” and “fields” as described below), that may be displayed to a user on a display device of a computing system and while utilizing the methods and systems described herein. Generally speaking, in some embodiments, the user may manipulate (e.g., arrange) the shapes and provide other user input (e.g., via user input devices, such as a mouse and keyboard) in order to generate the desired programming code (i.e., the system may generate programming code based on the arrangement of the shapes and other user input).

Structure:

The structure is the top-level of the snap environment. It may be compared to a project file in, for example, C# or Java in that it comprises a group of snap code which are interdependent on each other. Structures share global variables, types, functions, and subroutines. Each individual workspace is executed in a sortable order.

Workspaces:

Workspaces represent a block of snap code which is part of an overarching structure. Workspaces may allow users to separate code into distinct chunks for the purpose of organizing code. This may be similar to how a software engineer might separate code into individual files within a project.

Blocks:

In some embodiments, snap code (or language) is comprised of blocks which are “snapped” together (e.g., arranged in response to user input) to form logical expressions. The snap library may be used to create any block that is deemed useful for a specific application. For example, there may be snap blocks for changing geometry of objects in a 3D scene (e.g., changing the width, length, or height of a box). As another example, a snap block may also represent a very complex business operation that, via the snap environment, becomes very easy for the user to work with.

Parts—Anatomy of a Block:

A block may be made up of one or many parts. In some embodiments, the parts may include “connectors” and/or “fields.”

Connectors:

In some embodiments, connectors are the mechanisms which define where and how blocks may snap together (i.e., be connected). A connector on a block may either be connected to nothing (i.e., if the user has not connected anything yet) or connected to another connector on another block. In some embodiments, there are several different types of connectors for different purposes, such as output connectors, value connectors, statement connectors, and previous/next connectors.

Output Connectors:

FIG. 1 illustrates an output connector 10 according to some embodiments. In the depicted embodiment, the shape of the left side of the block 10 implies, for example, that the block 10 has some kind of return value that will feed into the logic expression of the block it is connected to.

Value Connectors:

FIG. 2 illustrates a value connector 12 according to some embodiments. Value connectors, such as that shown in FIG. 2, may expect a block or chain of blocks that will return some kind of value. Value connectors may mate with output connectors to form value-output connectors that can be analogized to assignment operations (e.g., x=1, where “=” represents the connection) or function calls (e.g., fn(x)).

Statement Connectors:

FIG. 3 illustrates a statement connector 14 according to some embodiments. Value connectors, such as that shown in FIG. 3, may imply a context of some sort (e.g., in a manner similar to curly braces in many code languages). Statement connectors may mate with previous connectors and may be analogized to indented operations seen in if statements, loops, and function declarations.

Previous/Next Connectors:

FIG. 4 illustrates a previous/next connector 16 according to some embodiments. Previous/next connectors may be for sibling blocks and control the imperative flow of the language.

Output connectors and previous/next connectors may be mutually exclusive in that a block may not contain both types at the same time. Also, in some embodiments, blocks containing output connectors may not have statement connectors.

In some embodiment, output connectors may only connect to value connectors, and statement connectors and next connectors may only connect to previous connectors.

Connectors may have different shapes depending on their purpose. For example, in some embodiments, code blocks use a triangular groove, which connect to other triangular grooves. Definition blocks may use a keystone-shaped groove, which connect to other keystone-shaped grooves. In some embodiments, connectors will only connect to other connectors which share the same shape.

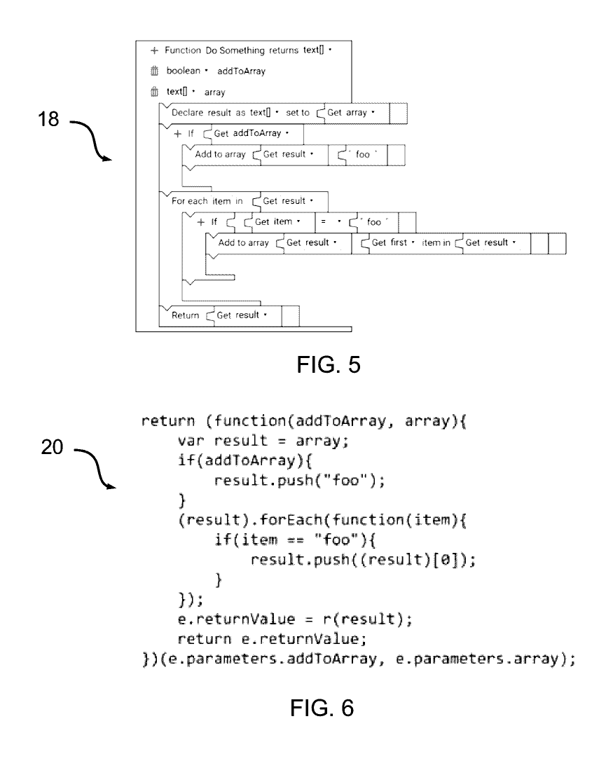

FIG. 5 illustrates an example of snap code 18 that demonstrates how the blocks connect to each other to form expressions. FIG. 6 illustrates code 20 that is based on the snap code shown in FIG. 5. That is, in some embodiments, the system may generate conventional software code (i.e., text-based code) in response to the user arranging snap blocks, connectors, etc. in a particular manner (i.e., the generated code is based on the arrangement of blocks formed by the user). In the specific example shown in FIG. 6, the code 20 is JavaScript, as will be understood by one skilled in the art. However, it should be understood that other types of code my also be generated, such as, C++, Java, Python, etc. Still referring to FIG. 6, note how similar the indentation and formatting is to the indentation created by the statement connectors shown in FIG. 5.

Fields:

In some embodiments, fields are controls on blocks which can be used to specify settings and options directly on the block. Fields may also include labels and other visual aids to identify a block and its purpose. Types of fields range from, for example, a simple text field or dropdown field to more specialized fields, such as color selectors. Fields may be very complex, storing values which can be configured via an interactive popup if necessary.

Block Shape:

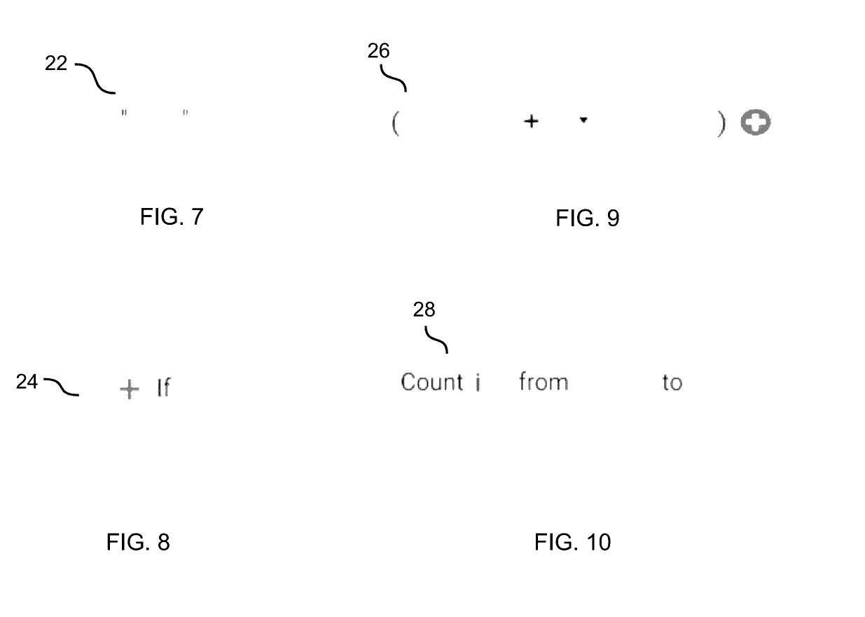

In some embodiments, blocks come in different shapes to conform to their function and layout. FIGS. 7-10 illustrate various example of block types/shapes.

FIG. 7 illustrates a literal string block 22 according to some embodiments. In some embodiments, the literal string block is among the simplest shapes. The notch on the left side indicates that it returns a value, in this case the content of a text field contained therein.

FIG. 8 illustrates an if block 24 according to some embodiments. In some embodiments, the if Block contains a value connector on the right side, and a statement connector, which is positioned below the “If” label.

FIG. 9 illustrates a math operation block 26 according to some embodiments. In the depicted embodiment, the math operation block contains two value connectors arranged horizontally in an “inline” layout.

FIG. 10 illustrates a loop block 28 according to some embodiments. In some embodiments, the loop block contains two value connectors arranged horizontally in an inline layout, and has a statement connector on the second line.

In some embodiments, blocks may have many connectors, as would be the case if an if Block were mutated to have one or more “else if” conditions and statements, and an “else” statement at the end (as described below).

Nesting Blocks:

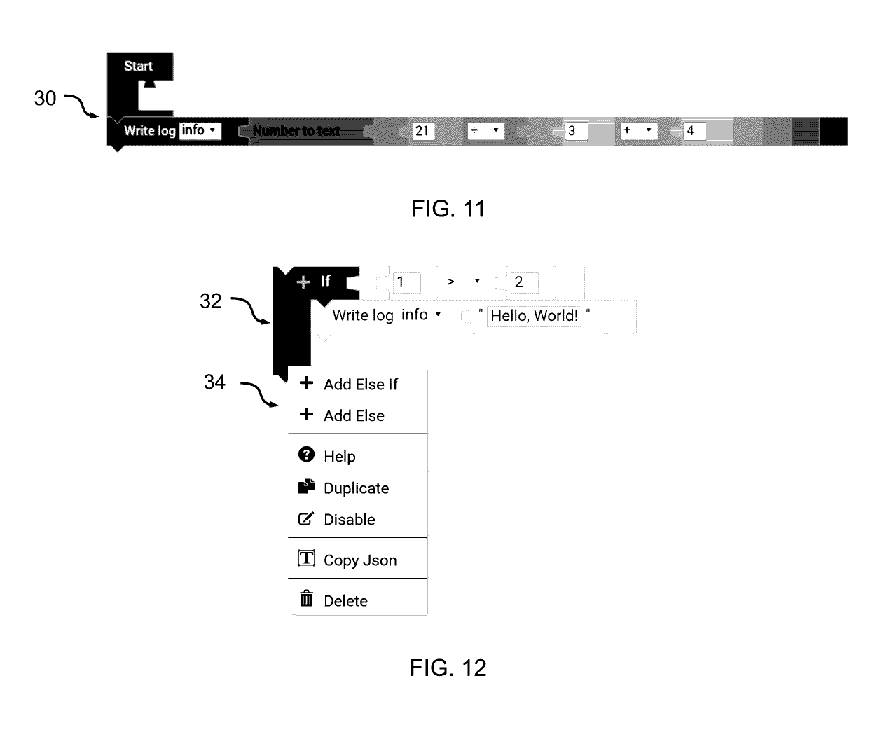

In some embodiments, blocks' values may nest within each other to produce powerful expressions. For example, the blocks (or snap code) 30 shown in FIG. 11 have operations nested, which results in, for example, a single value for the left-most block to receive. In some embodiments, execution is performed from the inner-most nested outward. In some embodiments, the further nested a block is, the lighter color it is shaded to aid the programmer visually. In the example shown in FIG. 11, there are two blocks, 3 and 4, which are the most nested. They are contained in an addition block, the next most-nested block. Because these blocks are the most nested, the program will execute this operation first, which will yield a result of 7. This value represents the right-hand value for the division block, whose left-hand value is 21. The division operation will then be executed, yielding a result of 3. The number value 3 is converted to text in the more outer block, which provides a valid text value for the log to receive as its value to write.

Still referring to FIG. 11, the mathematical expression within the illustrated block (or line of snap code) 30 is equivalent to 21/(3+4). Each nested level may be analogized to a parenthetical expression, which is why the order of operations did not apply in this example. In some embodiments, mathematical expressions may follow the standard order of operations if the operators are on the same nested level.

Selection:

In some embodiments, “clicking” on one or more blocks (e.g., with a user input device, such as a mouse, or when a touch screen is being used, a stylus or finger) within a workspace selects them. In some embodiment, particular keys, such as the “CTRL” key, may be used to select multiple blocks simultaneously. When blocks are selected, a context menu (e.g., a pop-up window) may be displayed with which the user may, for example, disable, delete, and/or duplicate those blocks, or perform operations that may be specific to those blocks.

Block Operation and Manipulation:

By clicking on fields within a block, right clicking and selecting an operation from the context menu, or striking keys on selected blocks, one can manipulate blocks, as described below.

Duplication:

In some embodiments, blocks may be duplicated instantly from the context menu. Duplicating blocks may be very useful in cases where the user needs many of the same group of blocks and would prefer to not have to repeatedly select them individually from the toolbox (i.e., a collection of blocks, etc. from which the user may select those he or she needs for the current project, as described below). Blocks may be duplicated along with any values, statements and nested blocks contained within.

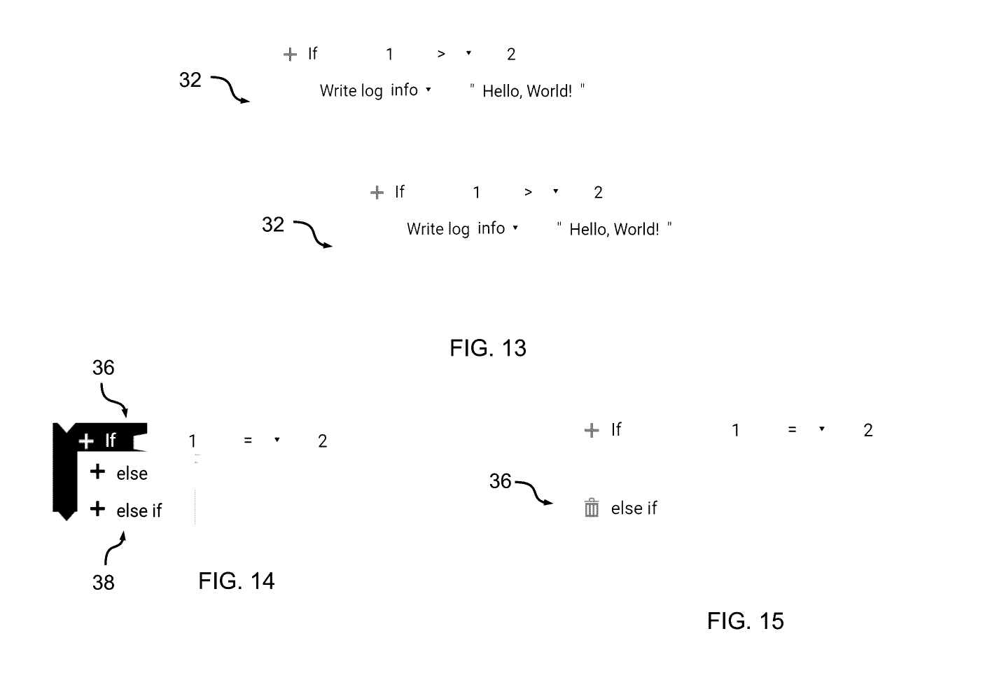

FIG. 12 illustrates a selected block 32 with a context menu 32 displayed thereover, with the “duplicate” option highlighted. After clicking/selected this highlighted option, the result is shown in FIG. 13, with block 32 having been duplicated. Note that not only block 32 is duplicated, but the blocks directly attached to block 32 are also duplicated.

Disabling Blocks:

In some embodiments, blocks may be disabled from the context menu (e.g., see FIG. 12). A disabled block may remain displayed in the workspace, but may be displayed in an altered color or intensity (e.g., “greyed out”). In some embodiments, when a block is disabled neither the block nor its connected values or statements will be executed at runtime. A disabled block may be analogized to “commented out” code in a text-based language. Disabling blocks may be useful if, for example, the user wishes to test how a program will perform with those blocks omitted before they are deleted entirely.

Mutation:

In some embodiments, some blocks can be mutated by the user. For example, a user may want to add an “else if” statement to an if block. For example, FIG. 14 illustrates a selected if block 36 with a menu 38 displayed thereover, which may be generated in response to the user clicking the “+” button on the if block 36. By selecting the “else if” option in the menu 38, the if block 36 mutates, as shown in FIG. 15 (i.e., the function of the block changes, as does the overall shape of the block).

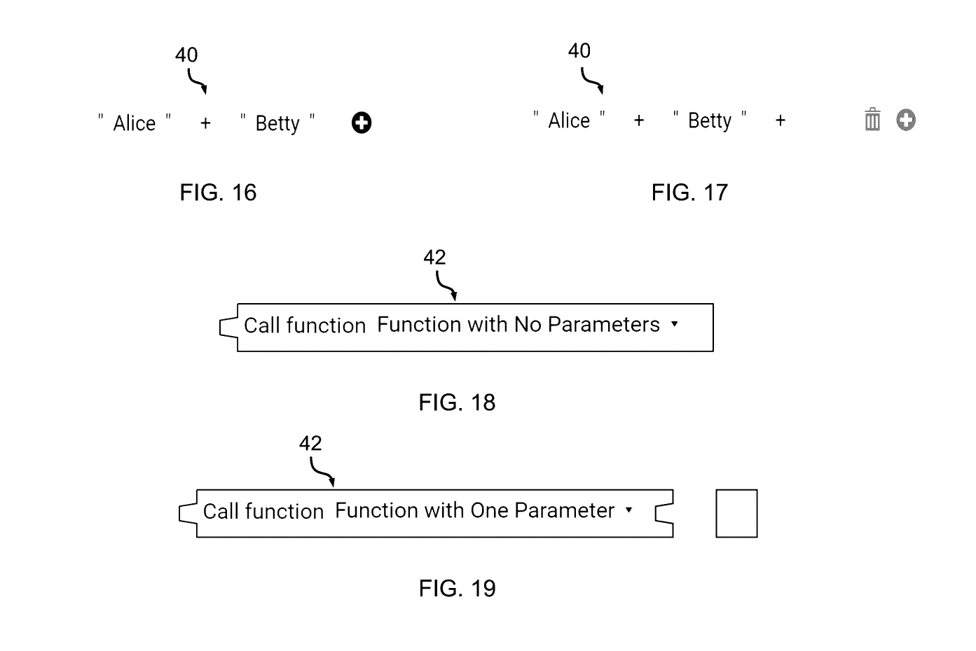

FIG. 16 illustrates a concatenate text block 42, which concatenates two strings of characters together. In some embodiments, clicking on the “+” button on the concatenate text block 42 adds another slot to insert a third string to concatenate, as shown in FIG. 17.

In some embodiments, blocks may be mutated to just about any shape, although most mutations will only append to an existing shape to give it more capabilities. Mutations may be undone, and restored to their original shape if desired. Some mutations are automatic, such as in cases where selecting a specific value from a dropdown (or pop-up menu) may add other connectors or fields, as is the case in FIG. 18, which illustrates a call function block 42, calling a function which has no parameters to pass in. By switching the dropdown embedded therein to a function with a single parameter, the block will mutate to what is shown in FIG. 19.

Get/Set Variable Context Menu Item:

In some embodiments, blocks which declare variables have a context menu item that allows one to easily add blocks to the workspace that access them, which would otherwise need to be accessed by dragging the get/set variable block out of the toolbox and then selecting the variable from the dropdown.

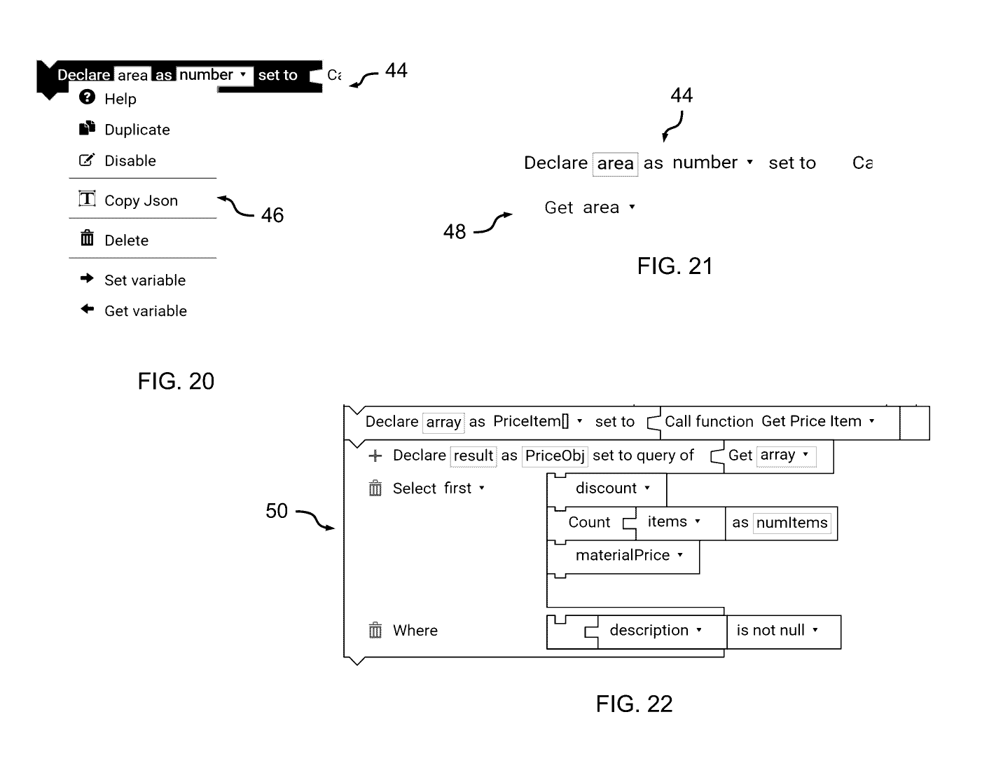

FIG. 20 illustrates a declare variable block 44 with a context menu 46 displayed thereover. Because the declare variable block 44 introduces a variable, the “get variable” and “set variable” options are shown on the context menu 46. After selecting “get variable” from the context menu 46, a get variable block 48 is generated, for example, below the declare variable block 44, with the variable pre-selected, ready to be placed where desired, as is shown in FIG. 21.

Keyboard Binds:

In some embodiments, clicking and dragging on blocks while holding certain modifier keys may influence what happens to the block. For example, in some embodiments, holding the CTRL key while clicking will add to the selection. In some embodiments, holding the “SHIFT” key while clicking will add any blocks between the last selected block and the clicked block to the selection. In some embodiments, holding CTRL while dragging the block will drag a new duplicate of the selected block(s), and holding SHIFT while dragging the block will splice it out of the workspace, if applicable, meaning any blocks connected below will become connected to the selected block's formerly connected previous connector.

Regions:

In some embodiments, to aid in the readability of the blocks (snap code), the user can separate blocks of code into separate regions which can be labeled. In addition, these regions may be collapsed and expanded to temporarily hide (but not disable) the blocks contained within.

Queries:

In some embodiments, a special query syntax is included which may be used for various sources of data, including external databases and arrays. Such a query block may follow a Structured Query Language (SQL)-like syntax which allows the user to select which columns from the query should be included, whether to retrieve the first result or a collection of results, and include where clauses and joins. The object that is returned may be of a dynamically defined type, allowing the user to take advantage of the auto-completion mechanism variable access blocks provide.

The blocks 50 shown in FIG. 22 include an array in which of PriceItem objects (e.g., which consist of a discount property, items array, and materialPrice property) are queried. PriceObj is a type which will have discount, materialPrice, and numItems properties.

Start Block & Definitions:

In some embodiments, each workspace has a start block associated with it. The start block may have two parts. The first part may allow the user to connect definition blocks which may be in the form of types, functions, or subroutines which can be custom defined for the purposes of the specific project (or snap code) they are working on. These definitions may use a different connector shape than the regular code blocks. The user may also snap a code block which will be considered the beginning of code execution. Any blocks that are not connected to a start block or blocks which are derived from the start block may remain in the workspace but will not be executed. They may be displayed in a different color or intensity (e.g., semi-transparent) to indicate that they are disconnected.

Functions and Subroutines:

In some embodiments, functions and subroutines may be declared by users. Functions may be operations which return a value of a specific type, while subroutines may be operations which perform actions without returning values. This distinction may be important because it defines how a block invoking functions and subroutines connects to other blocks. In some embodiments, a block that calls a function will always have an output connector, whereas a block that calls a subroutine will always have previous/next connectors.

Types:

In some embodiments, snap code is a strictly “typed” language. In addition to pre-defined primitives (e.g., text, number, array, and boolean), it allows the declaration of custom object oriented types which can contain function, subroutines, and properties. Like object-oriented languages, these functions and subroutines may access and manipulate their own properties. Types may also be pre-defined and injected into a structure from an external source. Examples of pre-defined types include, for example Boolean (i.e., a true or false value), number (in some embodiments, the snap environment does not differentiate between integers, floats, or doubles—each of them are of type number), text (i.e., strings of characters), date (i.e., represents a specific date and time), array, and map. Arrays may be special types which may represent a collection of other types. For example, a user may instantiate a variable to hold an array of text, and add text values to that array, or enumerate through the array in a loop. Maps may provide a means to provide a name-value pair. In generic terms, they may be considered anonymous objects, or they can be analogized to, for example, Dictionary types in .NET or HashMaps in Java.

The “Any” Type:

A value will always be of a specific type, however in certain cases, snap will allow connections of type “any” to mean it supports any type of output value from another block. An example of such a block is the “Serialize to JSON” block which can take any value and output a JSON formatted representation of that value.

Casting:

As a typed language, in some embodiments, the snap environment has a special “cast” block which allows one value to take on another type. Casting may be most useful if the user wants to express the number 100 as a text “100,” which in typed languages are two different values. If a block is connected to a value connector whose types do not match, the context menu may offer an option to automatically cast the block to the expected type, which will insert a “cast” block.

Variables & Scope:

In some embodiments, variables may be declared in any part of the code. They may be accessible within the scope they are defined. For example, if the user declares a variable within a function body, it may only be accessible from within that function. In some embodiments, the user cannot declare variables with the same name if their scope overlaps. Variables may also be globally injected into a structure.

In some embodiments, variable access is in the form of set blocks and get blocks. These blocks contain dropdowns that may provide contextual options for whichever declared variables are accessible in that scope.

When the user renames a declared block, all get/set references may be renamed to that name automatically. In some embodiments, the same is true for types, functions, and subroutines.

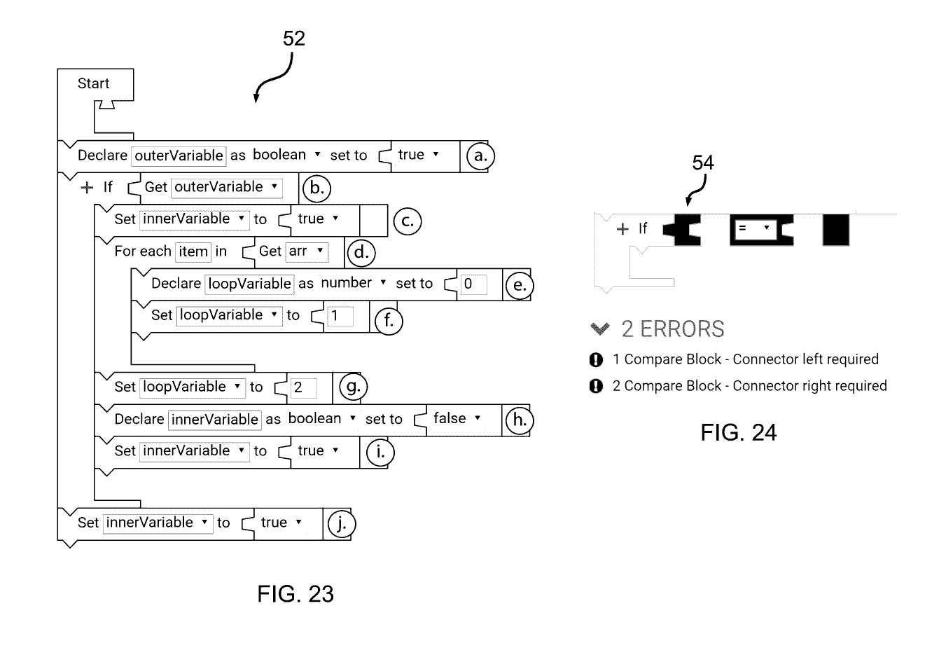

FIG. 23 illustrates a block (or series of blocks) 52 that demonstrates how “scope” works. Block line “a” declares “outerVariable,” which is accessible anywhere afterwards. Block line “b” is valid because it is defined after outerVariable is declared. Block line “c” attempts to access “innerVariable,” which is inaccessible because innerVariable is declared afterwards. Block line “d” adds “item” to the scope of the loop statement. It is only accessible within the loop itself, and “arr” is invalid, as it hasn't been declared within the workspace shown in FIG. 23. Block line “e” declares “loopVariable.” Like “item,” it is only accessible from within the loop statement. Block line “f,” sets loopVariable to another value, which is valid, since it is within the loop statement. Note that outerVariable is also accessible because it is declared above, and in a scope that wraps around the if blocks and loop blocks. Block line “g” attempts to access “loopVariable,” but this variable is inaccessible, because it was declared within the loop statement. Block line “h” declares innerVariable, which was inaccessible for the block in line c. Block line “i” sets innerVariable which is accessible due to line h. Block line “j” attempts to access innerVariable, but is inaccessible because innerVariable was declared within the if statement, and line j is outside of the if statement.

Validation:

In some embodiments, blocks may be validated to make the code more robust and consistent. Any invalid block may be equated to a compiler error in any other language, such as a text-based language. Because blocks can fill a very specific task or feature, they may validate themselves in a business-specific manner, which is unique to the language, as business logic is validated in runtime in other languages.

The block 54 shown in FIG. 24 is flagged as invalid because blocks need to be added to each of its value connectors.

Toolbox:

In some embodiments, blocks may be drag-and-dropped to the workspace from a “toolbox,” as referred to above. The toolbox may be arranged by different categories representing the overall function of the blocks. An example of such a category is “dates,” which may consist of blocks responsible for manipulating and formatting dates. The toolbox may also be filtered by typing into a provided search box, which may match blocks whose labels contain the keywords, or match an internal full text keyword list.

Buddy Blocks:

In some embodiments, certain blocks are paired intimately and often used together. For example, in some examples, a function declaration block will always have a return value block. To make block selection easier, these blocks may be organized into “buddy” blocks, which will appear in a panel on the workspace and may be dragged out when their associated block is selected in the workspace. For example, selecting a function declaration block may make the buddy block panel appear with the return value block inside.

Buddy blocks may be contextual to the specific way a block is being used. For example, in a set variable block, if the variable that is selected is a number type, its buddy blocks may be blocks pertaining to numbers. The same set variable block whose variable is a text type may instead have buddy blocks pertaining to text.

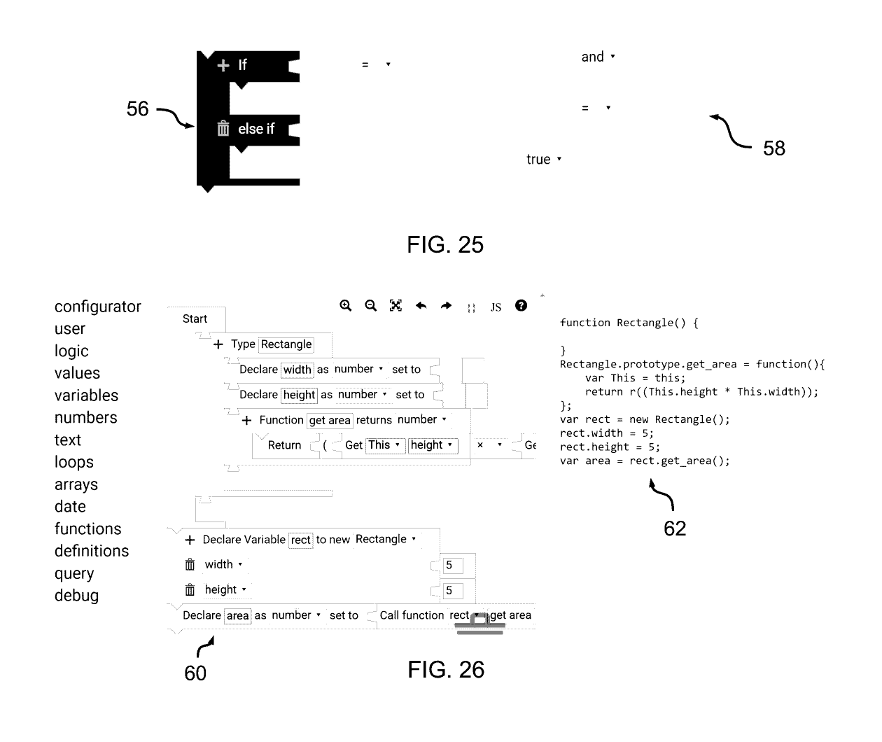

FIG. 25 illustrates an if block 56, selected, with commonly associated blocks 58 suggested as buddy blocks in the right-hand panel.

Buddy blocks may also be tied to (or associated with) individual connectors which are tightly coupled.

Code Generation:

As described above, snap blocks may be converted to executable code of any language (e.g., Javascript) for execution. FIG. 26 illustrates a series of snap blocks 60 along with the text-based code 62 (e.g., Javascript) that would be created from those blocks 60. In some embodiments, the user may view such code. The code that is generated may be used to customize any business software system.

In some embodiments, code for a block (or series of blocks) is only generated when the following are true: the block is enabled, and the block is either directly or indirectly (e.g., through a chain) connected to the start block (e.g., this only applies when a start block is present).

Persistence:

In some embodiments, a block may be serialized into a JSON object. Serialization may also enable the user to copy blocks from one workspace to another by, for example, right clicking on a block and selecting “Copy JSON.” Workspaces may have a button that allows the user to paste the JSON into it, which reassembles the blocks intact.

Workspace Operations and Manipulation:

In some embodiments, an entire workspace may be manipulated using a toolbar across the top of the workspace user-interface.

Undo/Redo:

Like most editors, the snap environment may have undo/redo functionality that allows the user to, for example, undo changes made via, for example, the standard CTRL+Z/CTRL+Y keyboard bindings, in addition to icons in the toolbar.

Zoom:

In some embodiments, the user may zoom in and out of the workspace by using, for example, the zoom toolbar buttons, using ctrl+mouse wheel on a mouse, and/or by pinching on a touch device.

Full Screen View:

In some embodiments, a workspace may be expanded to fill the entire browser window if desired. One can exit full screen view by pressing the Esc key.

Find and Replace:

In some embodiments, a user-interface that will prompt the user to enter a keyword to find a block within the structure (e.g., a collection of blocks) may be opened by, for example, pressing CTRL+F. Additional fields in this user-interface may narrow down the scope to only include a subset of workspaces within the structure, or to only include keywords within a certain context (e.g. only match variables which include the keyword).

In addition, in some embodiments, the user may replace these keywords, where applicable (only for writeable data), with a replacement field. The replacement may work globally on all matched keywords which can be rewritten.

Contextual Blocks:

In some embodiments, connectors may be highlighted directly by the user, which filters the toolbox to only show blocks that are valid to be connected to that connector.

Keyboard Mode:

In some embodiments, a “keyboard mode” may be initiated so that a snap workspace has the concept of a cursor. The only valid location for a cursor may be on a connector of a block. The user may use the tab key to move to the next connector on the block, or if there are no more connectors on the block, the first connector on the next block in the workspace. The user may start typing to bring up a list of blocks that are filtered based on the text typed and are valid for the cursor connector. Using the keyboard arrows, the user may select which of the blocks they want to place, and press enter to place it onto the workspace. The cursor is now placed on the first connector of the inserted block and the process can continue.

Collaboration:

In some embodiments, snap edits are broadcast live via web sockets, so that anyone who has the same workspace open can see the edits immediately after they occur. Multiple users may perform edits on the same workspace simultaneously for collaboration or training purposes.

Asynchronous Operations:

Taking consideration into asynchronous operations can be challenging, especially to novice or inexperienced programmers. In some embodiments, the snap environment hides this complexity by treating all asynchronous blocks identically to any other block in the code. A common asynchronous scenario is an HTTP call to a remote server. In most programming languages, such operations require, at the very least, an “async/await” keyword, and more commonly a callback function which handles the result of the call.

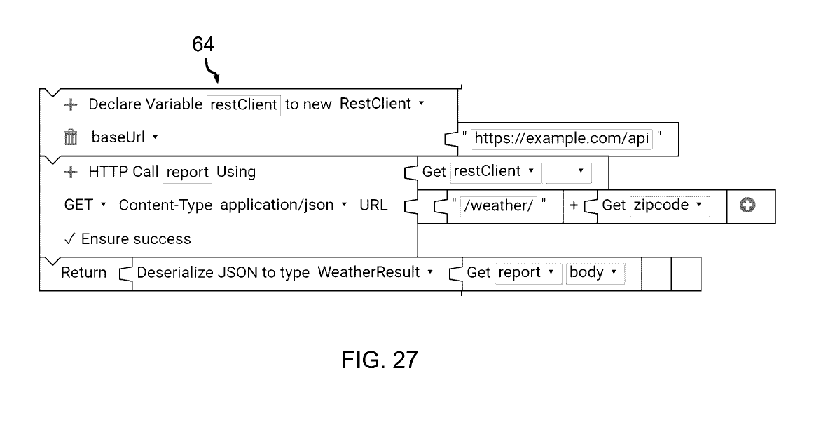

FIG. 27 illustrates blocks 64 in which a call is made to a sample web service that would provide a weather report. In many programming languages, making such a call would need to be handled in a different manner due to its asynchronous nature. Some embodiments described herein handle this seamlessly without the user needing to understand asynchronous functionality.

Non-Imperative Uses:

While the embodiments described herein are most often used as an imperative language, they may also be used declaratively, depending on the context. Snap blocks may instead represent a specific configuration construct (which one could compare to an XML or JSON document).

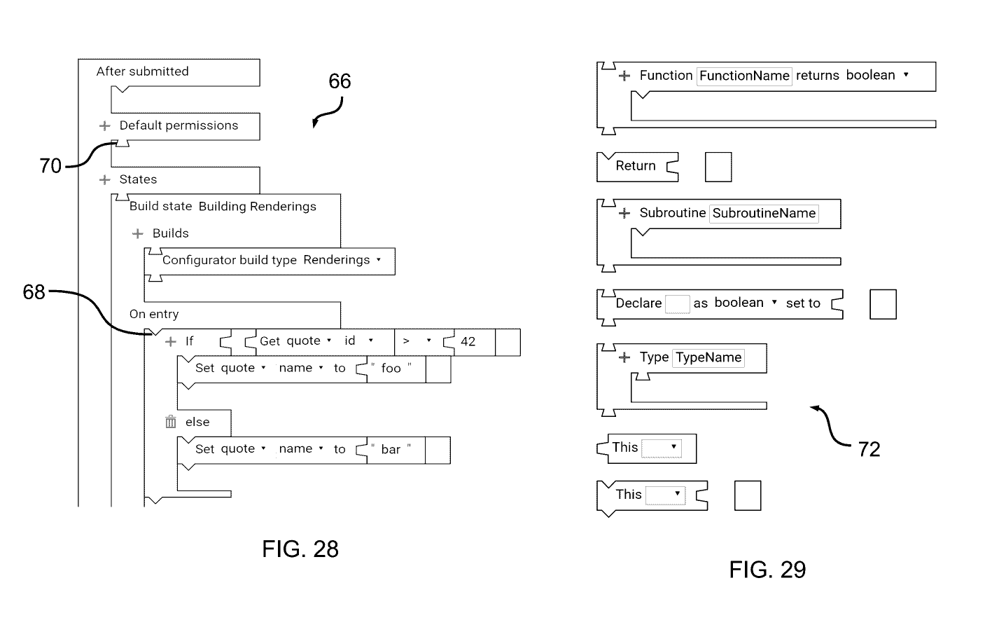

In addition, in some embodiments, a single workspace may be a hybrid of declarative and imperative languages. In the exemplary block structure 66 shown in FIG. 28, this hybrid functionality is demonstrated:

In FIG. 28, the overall workspace represents a workflow configuration consisting of states. This configuration is declarative. However, the “on entry” slot represents a imperative logical flow which names an entity depending on a condition. This code will run when the mechanism processing the declarative configuration enters the “Building Renderings” state. Note the difference in connector shapes which distinguishes declarative code from imperative code. The triangular pointed connector(s) 68 denotes imperative code, whereas the inverted keystone shaped connector(s) 70 denotes declarative code.

Documentation:

In some embodiments, blocks are documented using a dynamically generated embedded documentation page which describes each block. At a minimum, each block's documentation page may provide a diagram of the block with a descriptive name for each component, including any fields and connectors. Additionally, some blocks may go into deeper description of its function and how to use the block, as well as providing examples if needed. This mechanism may be designed such that the content of the documentation for the block is directly tied to the block's own definition, reducing the need to update documentation during updates or changes to the block.

Visual Design:

In some embodiments, the blocks are visually designed to be easy to read and well-suited for industrial-grade coding. The design philosophy may be to be concise in grammar, consistent in height, such that individual “lines” of code are spaced uniformly, and lacking in any distracting detail. For this reason, most blocks may be of a similar hue, with few exceptions where an important block may need to be accented (e.g., by displaying that block in a different color and/or intensity), and follow a consistent design pattern which is to make their function implicitly inferred.

Colors:

In some embodiments, blocks and their components are color coded to facilitate understanding what they represent, and what their status is. In some embodiments, most blocks are a first color, such as blue. However, certain special blocks such as blocks that contain code documentation and the start block may be a second color, such as in green. Blocks which have validation errors, such as an empty connector that's required to have a block in it, may then be displayed in a third color, such as red. Disabled blocks may be a fourth color, such as grey. Finally, a selected block may be a fifth color, such as orange.

In some embodiments, if there are other, special blocks, additional colors may be applied to them to indicate their importance and/or uniqueness.

Fields may also be color coded. For example, variable fields may have a yellow tint (e.g., a sixth color), and number fields may be slightly brighter than string fields (i.e., be displayed with a different intensity).

User Interface:

In some embodiments, the snap environment user interface (UI) includes the toolbox on, for example, the left, which contains the available blocks to drag out. A toolbar may extend across, for example, the top with workspace-level operations. The rest of the space (e.g., at the center) may be devoted to the main workspace where the blocks are arranged (e.g., the code is composed). In some embodiments, blocks may be added to the workspace via a “drag-and-drop” action from the toolbox. This same action may be used to manipulate (e.g., move, rearrange, etc.) the existing blocks within the workspace. A context menu may also be displayed when right-clicking blocks in the interface, as described above. A hidden panel on, for example, the right side may be displayed when certain actions are taken, including, for example, selecting a block which has buddy blocks, clicking to see the translated code that the blocks generate, and getting help documentation on the blocks.

Practical Uses:

The methods and systems described herein (i.e., snap environment) may be best used as an imperative or declarative language for technically minded people who do not necessarily possess an extensive software engineering background. It may be beneficial in allowing people with, for example, a mechanical engineering background to create, for example, complex configurators for custom and on-demand manufacturing. Such configurators may have a wide range of flexibility, but with many specific limits based on complicated algorithms and industry standards.

As such, the embodiments described herein may allow engineers to easily define these algorithms in a user-friendly manner with only a modern browser and some understanding of logic. Thus, most of the prerequisite knowledge is therefore expertise related to the product they are configuring, rather than in expertise in computer programming. Although expertise in computer programming is not required, the snap environment may guide engineers toward using principles that experienced software engineers have adopted, including “don't repeat yourself,” (made possible with function and subroutine declarations) and “single responsibility” (made possible by only offering blocks prudent to the context they are designed to be used in). The ability to create multiple snap code entities in succession also invites developers to modularize the code in such a way they can segment pieces of codes into these individual workspaces, reducing the possibility of there being a single monolithic workspace that can be more difficult to read and maintain.

As one example, configurator code in snap is, for example, executed both on the client-side as Javascript code run on the end-user's browser, and on the server-side as Javascript code run in Node. Server-side code may have the benefit of running proprietary logic that one would not want to expose to an end-user as client code.

Block Library:

General Code Blocks:

FIG. 29 illustrates various declaration blocks 72 according to some embodiments. In some embodiments, declaration blocks declare, for example, custom types, functions, and subroutines. These blocks are placed in a special connector within the start block before the code is executed.

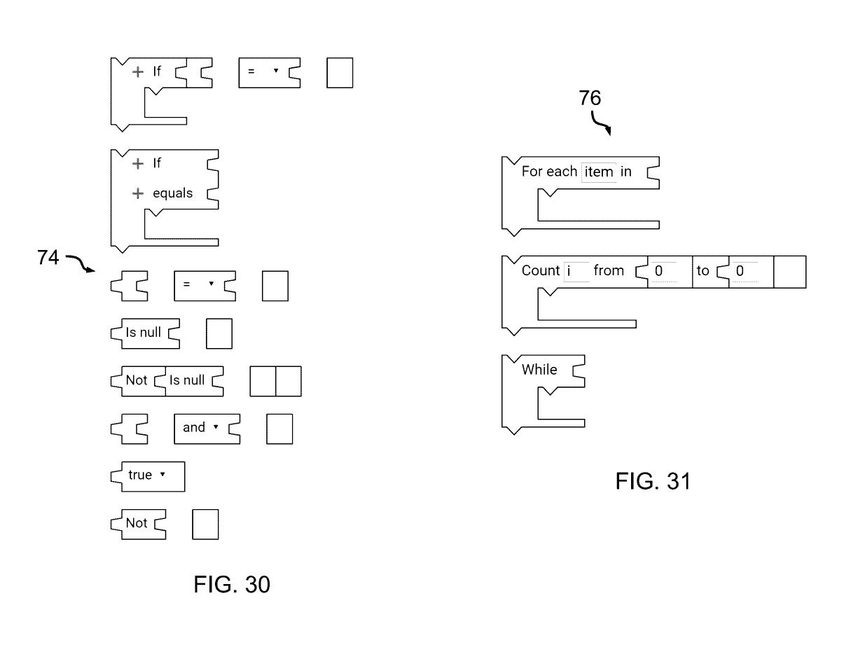

FIG. 30 illustrates various logic blocks 74 according to some embodiments. In some embodiments, logic blocks specify or handle true/false statements.

FIG. 31 illustrates various loop blocks 76 according to some embodiments. In some embodiments, loop blocks perform actions repeatedly until a condition has been satisfied.

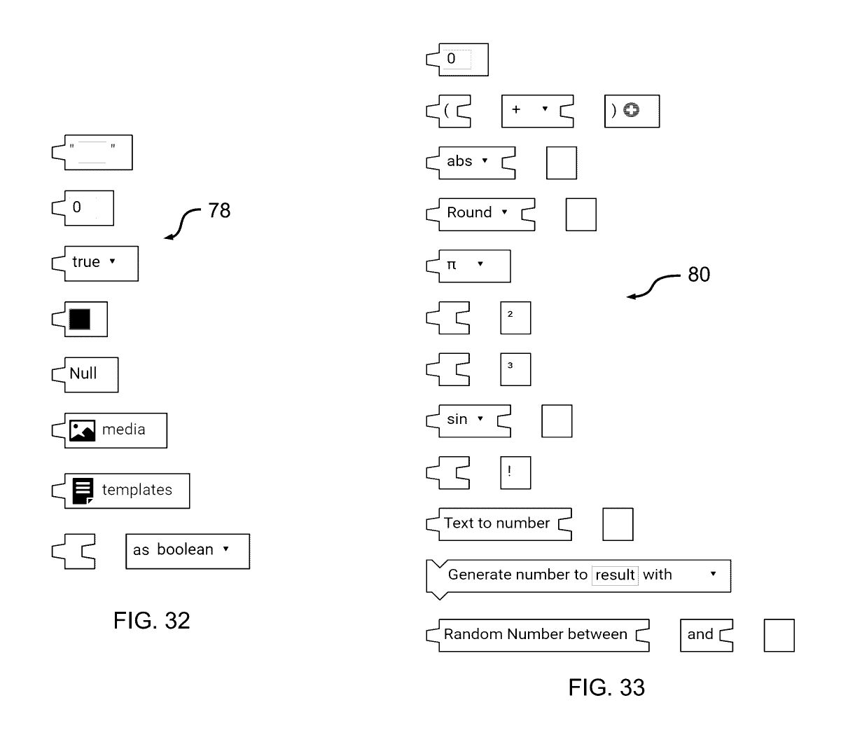

FIG. 32 illustrates various value blocks 78 according to some embodiments. In some embodiments, value blocks are simple blocks that, for example, define a specific hard-coded value.

FIG. 33 illustrates various number blocks 80 according to some embodiments. In some embodiments, number blocks perform arithmetic and mathematical operations, both simple and complex.

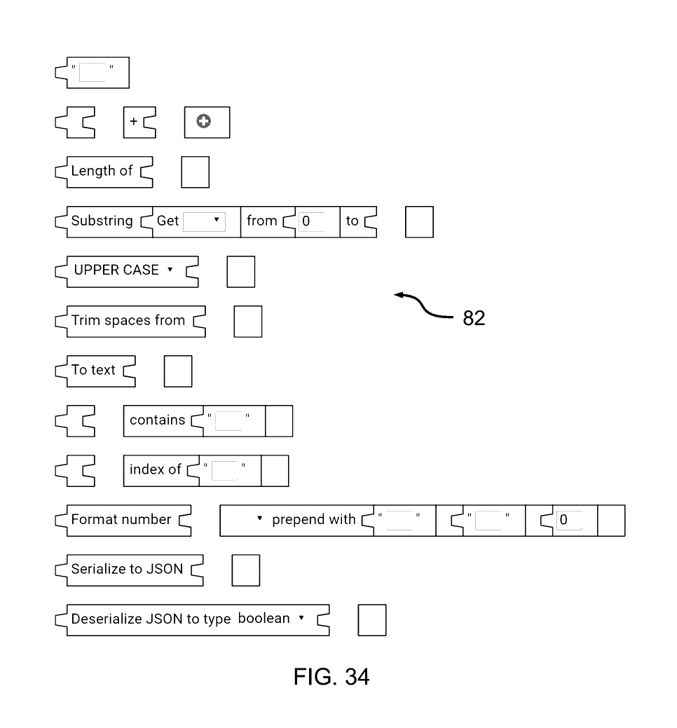

FIG. 34 illustrates various text blocks 82 according to some embodiments. In some embodiments, text blocks handle and manipulate alphanumeric values.

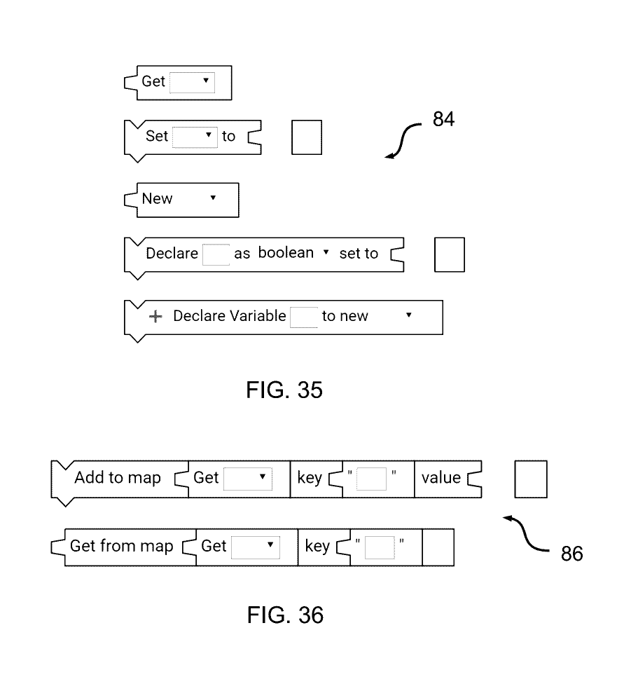

FIG. 35 illustrates various variable blocks 84 according to some embodiments. In some embodiments, variable blocks, declare, set, and get variable values.

FIG. 36 illustrates various map blocks 86 according to some embodiments.

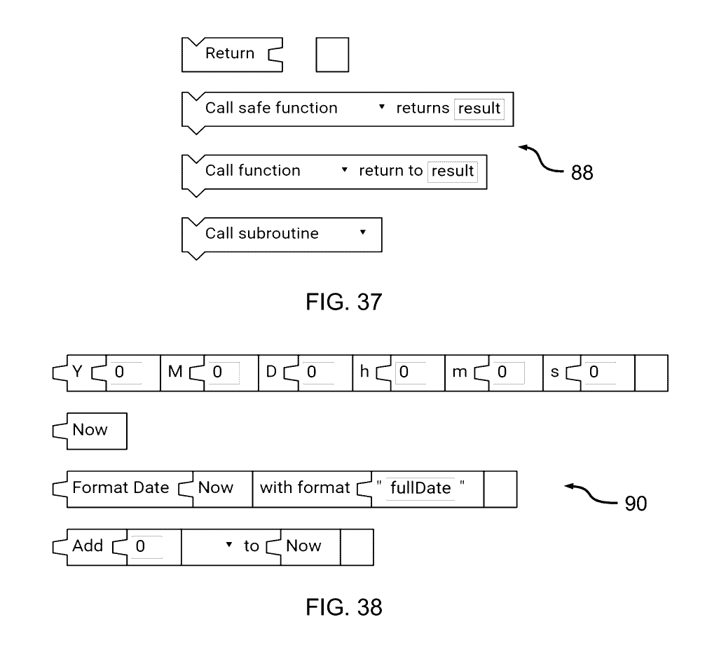

FIG. 37 illustrates various function blocks 88 according to some embodiments. Function blocks, for example, call functions and subroutines.

FIG. 38 illustrates various date blocks 90 according to some embodiments. In some embodiments, date blocks handle date arithmetic and formatting.

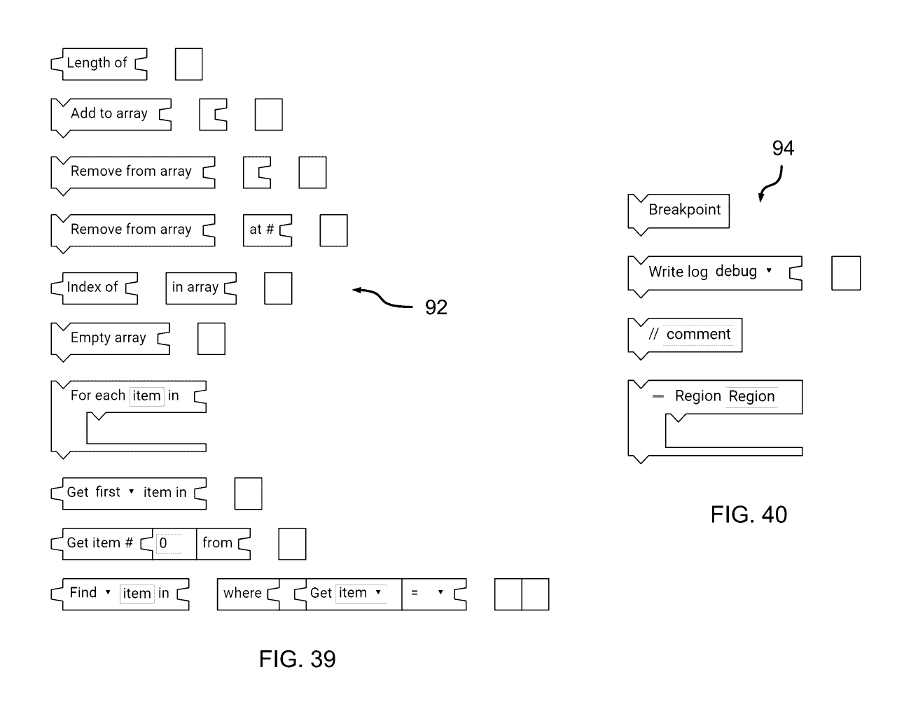

FIG. 39 illustrates various array blocks 92 according to some embodiments. In some embodiments, array blocks handle and manipulate lists of values.

FIG. 40 illustrates various debug blocks 94 according to some embodiments. In some embodiments, debug blocks aid the user in troubleshooting bugs or documenting code.

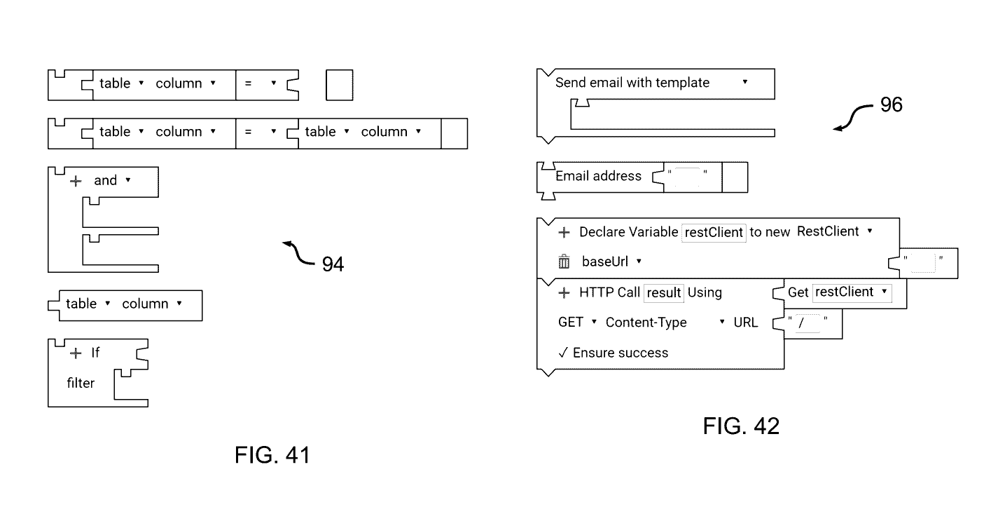

FIG. 41 illustrates various query blocks 96 according to some embodiments.

FIG. 42 illustrates various web blocks 96 according to some embodiments. In some embodiments, web blocks send HTTP and email calls.

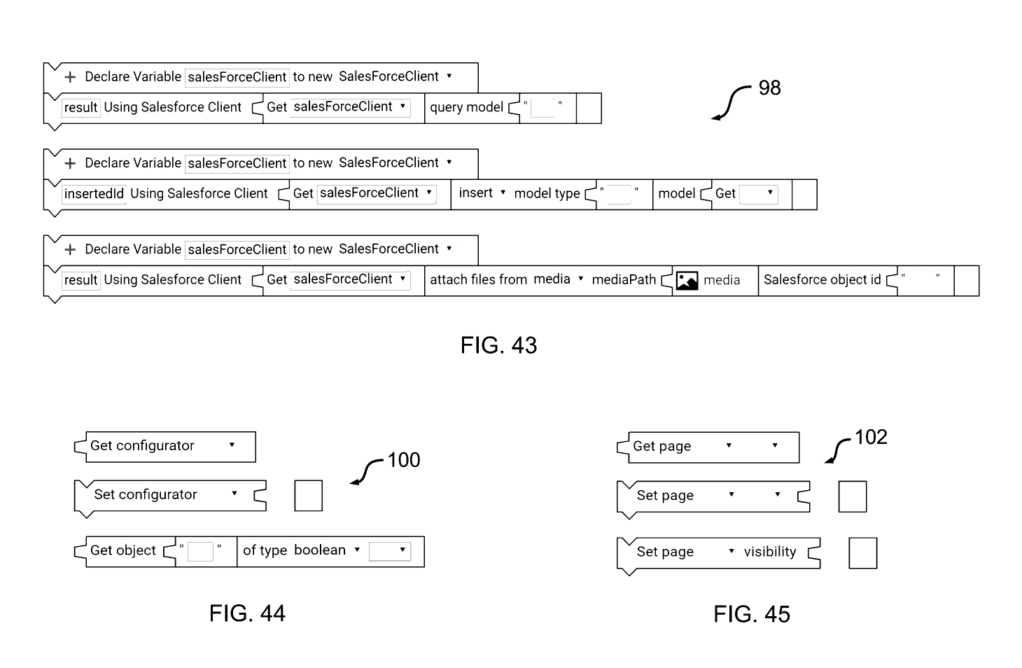

FIG. 43 illustrates various “salesforce” blocks 98 according to some embodiments. In some embodiments, salesforce blocks integrate with a Salesforce account.

FIGS. 44-50 illustrate various configurator blocks 100-112 according to some embodiments.

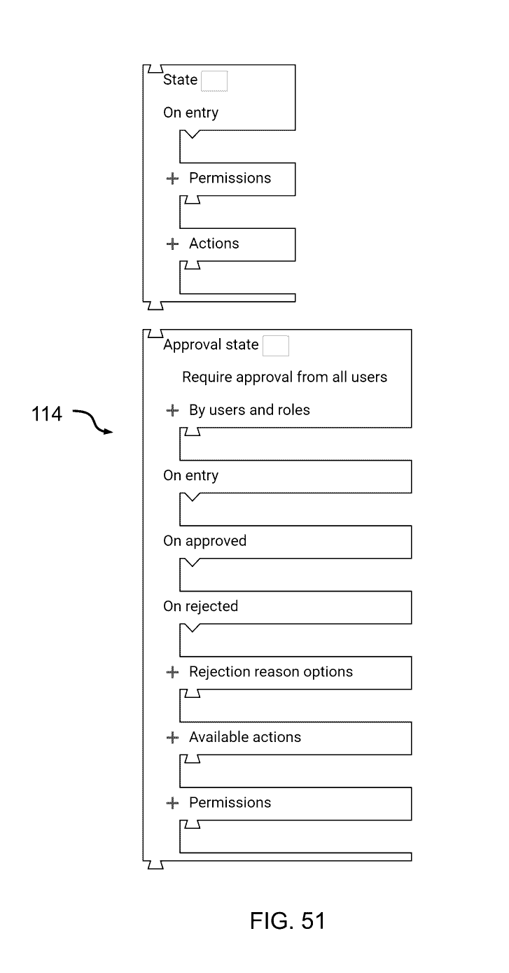

FIGS. 51-55 illustrate various workflow blocks 114-122 according to some embodiments.

Extensibility of Blocks:

The block examples mentioned above (FIGS. 29-55) demonstrate snap code which are either ubiquitous to programming logic or specific to the needs of the embodiment of the invention. However, some embodiments encompass a code library which could be extended by a trained software engineer to add new blocks, translations, and fields. This customizability may be beneficial because a user can create a single block which translates to a series of computer operations, which could represent logic specific to a business.

Program Examples:

FIGS. 56-58 illustrate several exemplary “complete” or “full” snap code programs according to some embodiments.

In the snap code program 124 shown in FIG. 56, two variables are declared, i and exponent. The included while block executes the two blocks contained in its statement connector repeatedly until the exponent's value is greater than 100. After this, a log is written that states how highest value of the variable i before the exponent exceeded 100.

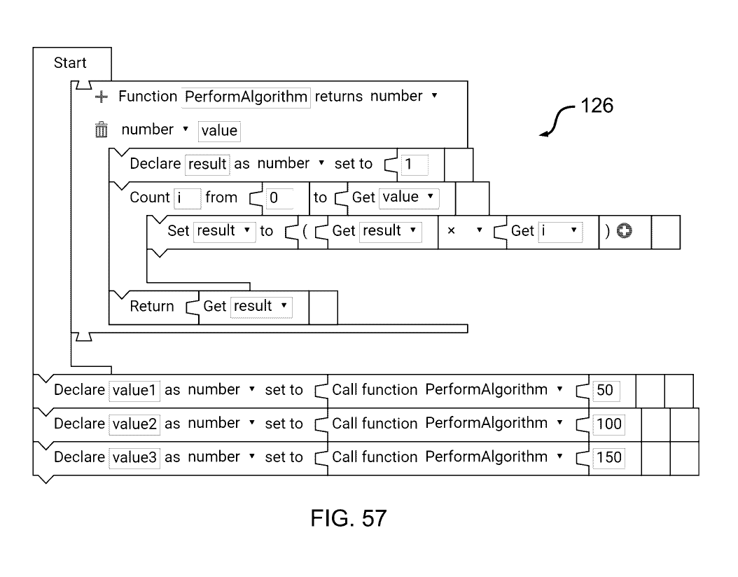

In the snap code program 126 shown in FIG. 57, a function performs a certain algorithm. The function has a parameter passed in, “value,” which is set to 50, 100, and 150 when the function is called in succession. The greatest benefit in declaring functions may be that they keep complex, but commonly used, logic in one place. This may simplify the code, and allow one to reference the same logic without having to repeatedly duplicate the same group of blocks. If the algorithm needs to change later due to new requirements or to fix a flaw, it only needs to be changed in the function declaration.

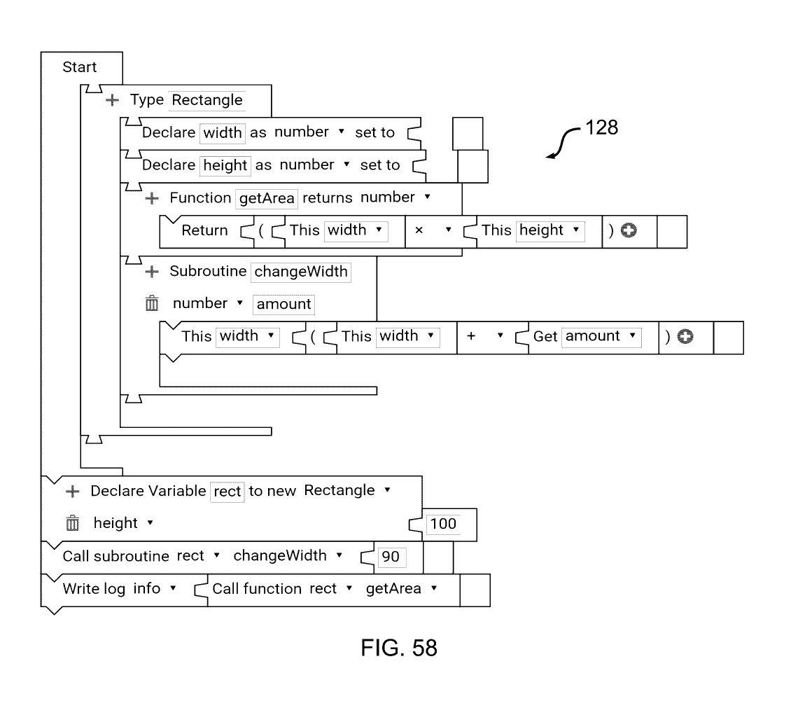

The snap code program 128 shown in FIG. 58 illustrates how custom types work. The custom “rectangle” type has two properties, “width” and “height,” each with default values of 10. A function calculates the area of the rectangle, and a subroutine allows one to change the width by a certain amount. In the program itself, a new rectangle is created, its height property is set to 100, and its width is increased by 90 (making its value also 100, since it was originally set to 10). A log then writes the rectangle's area, which in this case will be 10,000.

Thus, in some embodiments, simple, streamlined, and robust methods and systems for generating programming code are provided. The code described above may be a strictly typed language, with the ability to create your own types. The ability to combine multiple snap code workspaces may be provided. The blocks described above may be easily mutated (e.g., with a click or two). The connectors described above may vary in shape depending on the intended use (e.g., declarative language vs. imperative language). The code may also provide variable scoping, query blocks (e.g., query databases and arrays), validation, single line nested blocks, asynchronous call handling, webservice calls, and a start block and definitions.

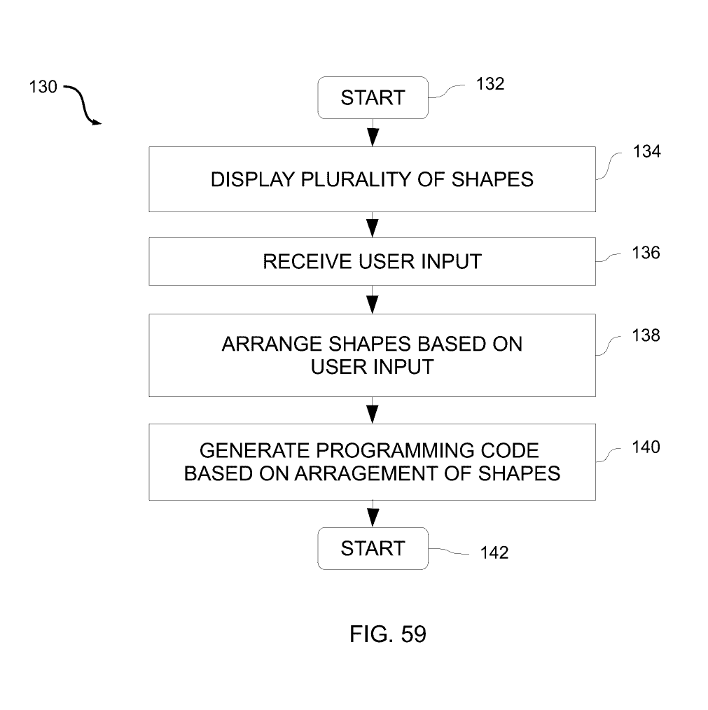

FIG. 59 illustrates a method 130 for generating programming code according to some embodiments of the present invention. The method 130 begins at block 132 with, for example, a plurality of shapes (e.g., connectors, fields, blocks, etc., as described above) being associated with various functionalities related to programming code, as is described above. In some embodiments, at least some of the shapes are polygons. In some embodiments, at least a portion of at least some of the plurality of shapes is non-alphanumeric.

At block 134, the plurality of shapes are displayed to the user, such as on a display device (e.g., a computer screen). As described above, the shapes may initially be displayed with a toolbox which forms part of the user interface of the methods and systems described herein. At block 136, user input is received. As described above, the user input may include indications of the user desiring to arrange the shapes in a particular manner (or configuration, structure, etc.). In some embodiments, the user input is performed by “dragging-and-dropping” the shapes (e.g., using a mouse, or similar device). However, the user input may also include various text-based input (e.g., fields).

At block 138, the shapes are arranged based on the received user input. Although block 138 is shown as being a separate step from block 136, it should be understood that in some embodiments, the two steps are essentially performed at the same time.

At block 140, programming code is generated based on the arrangement of the shapes, perhaps in combination with the functionalities associated with each of the shapes, such that the programming code provides an overall functionality that includes the respective functionality associated with each of the plurality of shapes. The programming code may be text-based programming code, such as, Javascript, C++, etc. In some embodiments, the generated programming code is displayed (i.e., to the user), such as on the display device.

At block 142, the method 130 ends. It should be understood that the method 130 may be understood to be a simplified example of the various methods described herein. As such, in some embodiments, the method may include additional steps and features, such as those described above.

It should be understood that although this disclosure includes a description of cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Exemplary characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Exemplary service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Exemplary deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

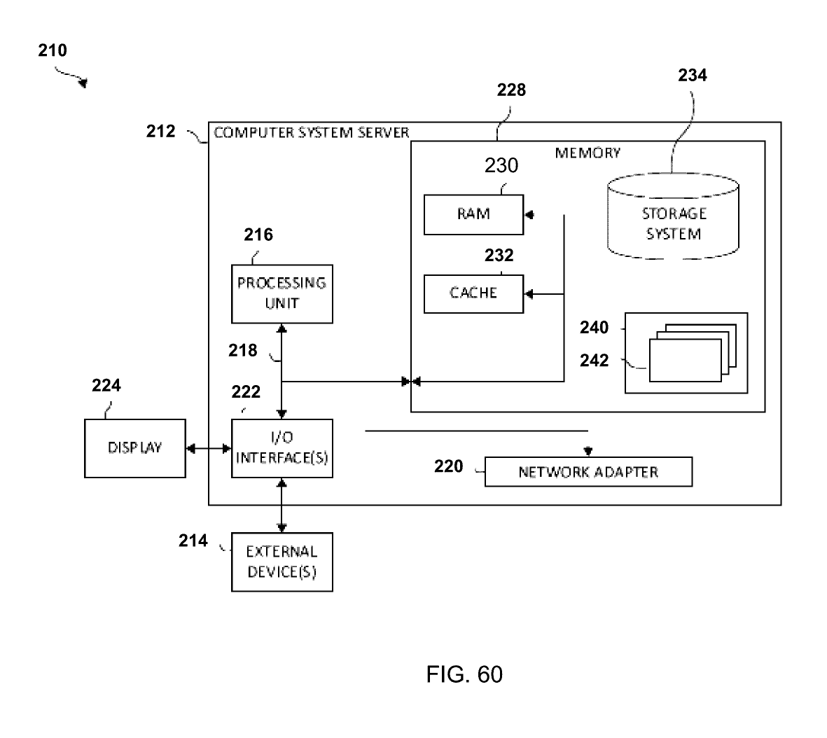

Referring now to FIG. 60, a schematic of an example of a cloud computing node is shown. Cloud computing node 210 is only one example of a suitable cloud computing node and is not intended to suggest any limitation as to the scope of use or functionality of embodiments of the invention described herein. Regardless, cloud computing node 210 is capable of being implemented and/or performing any of the functionality set forth hereinabove.

In cloud computing node 210 there is a computer system/server 212, which is operational with numerous other general purpose or special purpose computing system environments or configurations. Examples of well-known computing systems, environments, and/or configurations that may be suitable for use with computer system/server 212 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 212 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 212 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 60, computer system/server 212 in cloud computing node 210 is shown in the form of a general-purpose computing device. The components of computer system/server 212 may include, but are not limited to, one or more processors or processing units 216, a system memory 228, and a bus 218 that couples various system components including system memory 228 to processor 216.

Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 212 typically includes a variety of computer system readable media. Such media may be any available media that is accessible by computer system/server 212, and it includes both volatile and non-volatile media, removable and non-removable media.

System memory 228 can include computer system readable media in the form of volatile memory, such as random access memory (RAM) 30 and/or cache memory 232. Computer system/server 212 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, system memory 228 may include at least one program product having a set (e.g., at least one) of program modules that are configured to carry out the functions of embodiments of the invention.

Program/utility 240, having a set (at least one) of program modules 242, may be stored in system memory 228 by way of example, and not limitation, as well as an operating system, one or more application programs, other program modules, and program data. Each of the operating system, one or more application programs, other program modules, and program data or some combination thereof, may include an implementation of a networking environment. Program modules 242 generally carry out the functions and/or methodologies of embodiments of the invention as described herein.

Computer system/server 212 may also communicate with one or more external devices 214 such as a keyboard, a pointing device, a display 24, etc.; one or more devices that enable a user to interact with computer system/server 212; and/or any devices (e.g., network card, modem, etc.) that enable computer system/server 212 to communicate with one or more other computing devices. Such communication can occur via Input/Output (I/O) interfaces 222. Still yet, computer system/server 212 can communicate with one or more networks such as a local area network (LAN), a general wide area network (WAN), and/or a public network (e.g., the Internet) via network adapter 220. As depicted, network adapter 220 communicates with the other components of computer system/server 212 via bus 218. It should be understood that although not shown, other hardware and/or software components could be used in conjunction with computer system/server 212. Examples include, but are not limited to: microcode, device drivers, redundant processing units, external disk drive arrays, RAID systems, tape drives, and data archival storage systems, etc.

In the context of the present invention, and as one of skill in the art will appreciate, various components depicted in FIG. 59 may be located in, for example, personal computer systems, hand-held or laptop devices, and network PCs. For example, some of the processing and data storage capabilities associated with mechanisms of the illustrated embodiments may take place locally via local processing components, while the same components are connected via a network to remotely located, distributed computing data processing and storage components to accomplish various purposes of the present invention. Again, as will be appreciated by one of ordinary skill in the art, the present illustration is intended to convey only a subset of what may be an entire connected network of distributed computing components that accomplish various inventive aspects collectively.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method, by a processor, for generating programming code, comprising:
displaying a plurality of shapes on a display device, wherein each of the plurality of shapes is associated with a respective functionality of programming code;
receiving user input;
based on the user input, arranging the plurality of shapes on the display device; and
based on said arrangement of the plurality of shapes, generating programming code, wherein a total functionality of the generated programming code comprises the respective functionality of programming code associated with each of the plurality of shapes.

2. The method of claim 1, wherein the generated programming code is text-based programming code.

3. The method of claim 2, wherein the text-based programming code is Javascript, Java, C++, C#, or Python.

4. The method of claim 3, further comprising displaying the text-based programming code on the display device.

5. The method of claim 1, wherein the plurality of shapes comprises a plurality of polygons.

6. The method of claim 1, wherein at least a portion of each of the plurality of shapes is non-alphanumeric.

7. A system for generating programming code, comprising:
a processor that
displays a plurality of shapes on a display device, wherein each of the plurality of shapes is associated with a respective functionality of programming code;
receives user input;
based on the user input, arranges the plurality of shapes on the display device; and
based on said arrangement of the plurality of shapes, generates programming code, wherein a total functionality of the generated programming code comprises the respective functionality of programming code associated with each of the plurality of shapes.

8. The system of claim 8, wherein the generated programming code is text-based programming code.

9. The system of claim 8, wherein the text-based programming code is Javascript, Java, C++, C#, or Python.

10. The system of claim 9, wherein the processor displays the text-based programming code on the display device.

11. The system of claim 10, wherein the plurality of shapes comprises a plurality of polygons.

12. The system of claim 7, wherein at least a portion of each of the plurality of shapes is non-alphanumeric.

13. A computer program product for generating programming code by a processor, the computer program product comprising a non-transitory computer-readable storage medium having computer-readable program code portions stored therein, the computer-readable program code portions comprising:
an executable portion that
displays a plurality of shapes on a display device, wherein each of the plurality of shapes is associated with a respective functionality of programming code;
receives user input;
based on the user input, arranges the plurality of shapes on the display device; and
based on said arrangement of the plurality of shapes, generates programming code, wherein a total functionality of the generated programming code comprises the respective functionality of programming code associated with each of the plurality of shapes.

14. The computer program product of claim 13, wherein the generated programming code is text-based programming code.

15. The computer program product of claim 14, wherein the text-based programming code is Javascript, Java, C++, C#, or Python.

16. The computer program product of claim 15, further including an executable portion that displays the text-based programming code on the display device.

17. The computer program product of claim 13, wherein the plurality of shapes comprises a plurality of polygons.

18. The computer program product of claim 13, wherein at least a portion of each of the plurality of shapes is non-alphanumeric.
